(19) United States
(12) Patent Application Publication
(10) Pub. No.: US 2007/0113249 A1
(43) Pub. Date: May 17, 2007

(54) Context information management system and method

(76) Inventors: Kyung-Sook Kim, Daejeon-city (KR); Jung-Sook Bae, Dae-jeon-city (KR); Gyung-Chul Sihn, Dae-jeon-city (KR)

Correspondence Address: LADAS & PARRY LLP, 224 SOUTH MICHIGAN AVENUE, SUITE 1600, CHICAGO, IL, 60604, US

(21) Appl. No.: 11/519,295

(22) Filed: Sep. 12, 2006

(30) Foreign Application Priority Data
Nov. 15, 2005 (KR) 10-2005-0108964

(51) Int. Cl. H04N 5/445; H04N 7/16; G06F 13/00; G06F 3/00

(52) U.S. Cl. 725/45; 725/135; 725/136; 725/46

(57) ABSTRACT

A context information management system provides service mobility that allows user to maintain service even while moving the service environment. That is, when user service environment movement is sensed, user service provided in previous service environment is consecutively provided to the user in the new service environment using the service context information of user service provided in the previous service environment. In such a manner, the service user may continuously use a same service that used in the previous service environment although the user moves to other service environments without a service terminal.

### BACKGROUND OF THE INVENTION

(a) Field of the Invention

The present invention relates to a context information management system and method.

(b) Description of the Related Art

Recently, the range of computer usage has expanded from a personal computing area to a ubiquitous computing area as information industry and mobile communication technology have been developed. In the ubiquitous computing service, a terminal senses changes in the environment and automatically adapts and acts based on these changes based on user needs and preferences, and a computer senses a state of a user, analyzes the sensed context, and provides a personalized service appropriate to the context. Accordingly, services are required to adaptively vary according to a context including a present user location, and a user activity as well as service capabilities of service terminal in a ubiquitous computing environment.

As the related art, IEEE Communications Magazine discloses a SIP (Session Initiation Protocol)-based system for the ubiquitous computing of a home network. In order to provide the ubiquitous computing in a home network, the SIP (Session Initiation Protocol)-based system discoveries available service apparatus in user current location and provides a service by utilizing service capability of the service apparatus. This technology may have a merit in that the user is provided with a service by utilizing a service capability of service apparatus in user current location when the user moves. However, it does not consider service mobility schemes for continuously providing the service while applying the same user service preference in the case that the user moves to other locations on the way of using a service.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide context information management system and method having advantages of providing service mobility that allows user to maintain service even while moving the serve environments without a service terminal.

An exemplary embodiment of the present invention provides a context information management system for providing a user having moved service environments with service mobility. The context information management system may include a service controller for providing a service according to necessary context information and context information conditions for performing a service by analyzing a service based on service subscription information of a user making an entry into a service environment; and a context information manager for context configuration to gather and manage the necessary context information and transmitting the context information of service provided in the previous service environment to the service controller when the user mobility of the service environment is sensed from the gathered context information. The service controller may continuously provide the same service to the service-environment-moved user with the same user preference by using the context information of service provided in the previous service environment.

Another embodiment of the present invention provides a context information management method for providing service mobility to a user that moves from a first service environment to a second service environment. The context information management method may include a) recognizing an entry of the user into the second service environment; b) context configuration for gathering and managing the context information according to user service requirements by analyzing a service based on the service subscription information of the user of the entry; c) sensing a movement of the user from a first service environment to a second service environment from the context information gathered by the context configuration; and d) receiving the context information of service provided in the previous service environment from the first service environment and providing the same service with the same user preferences as that of the first service environment to the user having moved to the second service environment.

### BRIEF DESCRIPTION OF THE DRAWINGS

FIG. 1 illustrates a context information management system according to an exemplary embodiment of the present invention.

FIG. 2 illustrates a context information management system when a user moves to other service environments.

FIG. 3 illustrates an operation process of a context information management system when a user makes an initial entry into a service environment.

FIG. 4 illustrates an operation process of a context information management system when a user moves into other service environments by way of using a service.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. When it is described that an element is coupled to another element, the element may be directly coupled to the other element or coupled to the other element through a third element.

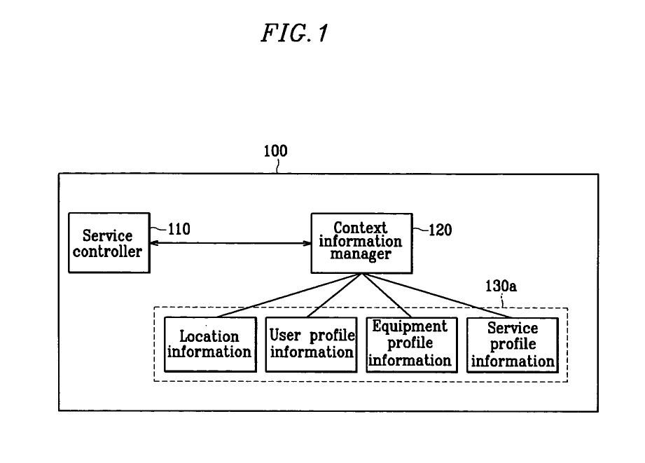

A context information management system and method according to an exemplary embodiment of the present invention will now be described with reference to FIG. 1 to FIG. 4.

FIG. 1 illustrates a context information management system according to an exemplary embodiment of the present invention.

As shown in FIG. 1, a context information management system 100 includes a service controller 110, a context information manager 120, and an information storage unit 130.

The service controller 110 senses a user entry (log-on) and exit (log-off) of a service environment and controls a user service, and provides service mobility when the user moves to other service environments.

Specifically, when the user makes an entry into any one service environment, the service controller 110 analyzes user service requirements using user service subscription information, requests the context information manager 120 to context configuration of context information and context information condition that it is necessary for a service to be performed, receives a context information notification of the context configuration request from the context information manager 120, and provides a service to the user according to the user requirement.

In addition, the service controller 110 requests the context information manager 120 to configure additional context information with respect to additional service requirement, receives a reply to the context request, and provides a desired service to the user according to the user requirement. Herein, the context may imply such user information as a user's present location, a user's behavior, and work in the service environment that the user has undergone, user service information, and changes thereof. Such context information obtained from the user's service environment may be used in the present system or may be registered on the server through the network or used in other places. The stored context information may be occasionally used or performed by other terminals coupled to the ubiquitous network.

The context information manager 120 manages the user context information and the user service context information, and performs the user service context information exchange such that the user is continuously provided the service used in the previous service environment when the user moves to other service environments. In more detail, the context information manager 120 receives the context configuration request from the service controller 110, gathers and maintains the context information by configuring necessary context information, and transmits the context information to the service controller 110 as a context information notification when the context information conditions are formed.

The information storage unit 130 stores the user context information and user service context information so as to support service mobility.

Such context information may include user location information, user profile information, device profile information, and service profile information.

The user location information includes the user present and previous location information. The user profile information includes a user's service device preference, an automatic/manual preference of the service mobility modes, and automatic/manual preference of the service device selection modes. Such user profile information may be changed according to the user requirements. The device profile information includes a list and specification information of device that the user may utilize at the present location. In addition, the service profile information includes using service information. At this time, the context information manager 120 may manage user location information by recognizing a user tag including user identifier information using location recognizing technology, and manage device profile information using device discovery technology.

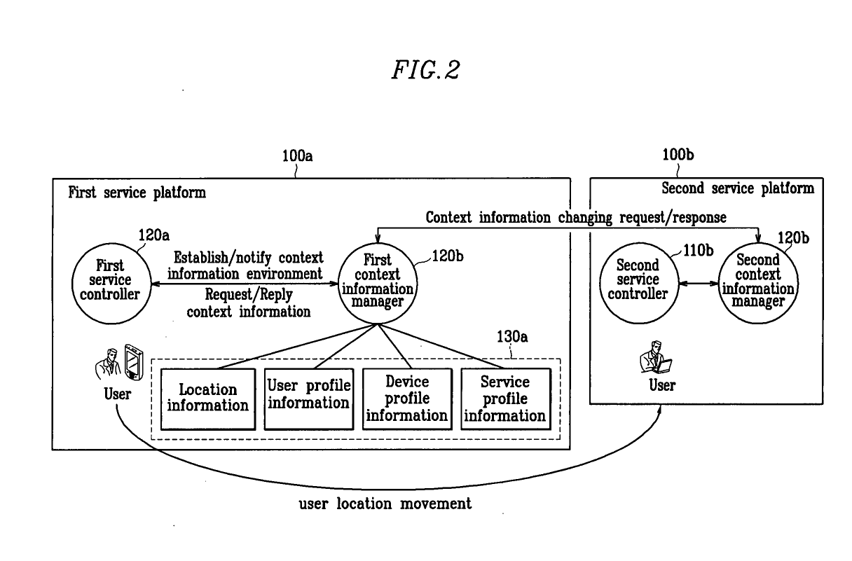

FIG. 2 illustrates a context information management system when a user moves to other service environments. Hereinafter, a service platform of a first service environment is defined as a first service platform, and a service platform of a second service environment is defined as a second service platform. In addition, a service controller and context information manager of the context information management system operated in the first service platform are illustrated as a first service controller 110a and a second service controller 120a, and a service controller and context information manager of the context information management system operated in the second service platform are illustrated as a first service controller 110b and a second service controller 120b.

As shown in FIG. 2, when the user moves from the first service environment to the second service environment, the first service controller 110a senses a user exit from the first service environment, and transmits the using service information to the first context information manager 120a. The second context information manager 120b senses mobility into the second service platform from the user location context information, requests the first context information manager 120a to provide a context information exchange about the user preference and the using service, and receives such context information from the first context information manager 120a.

With such an operation, the user may continuously maintain the using service in the previous service platform by a new service platform by means of applying the same user preferences in the new service platform as in the previous service platform although the user moves to the second service environment without a service terminal.

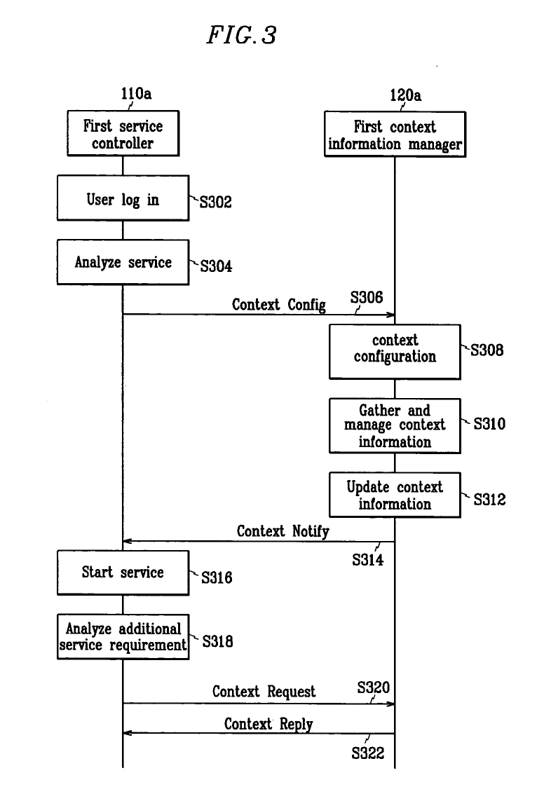

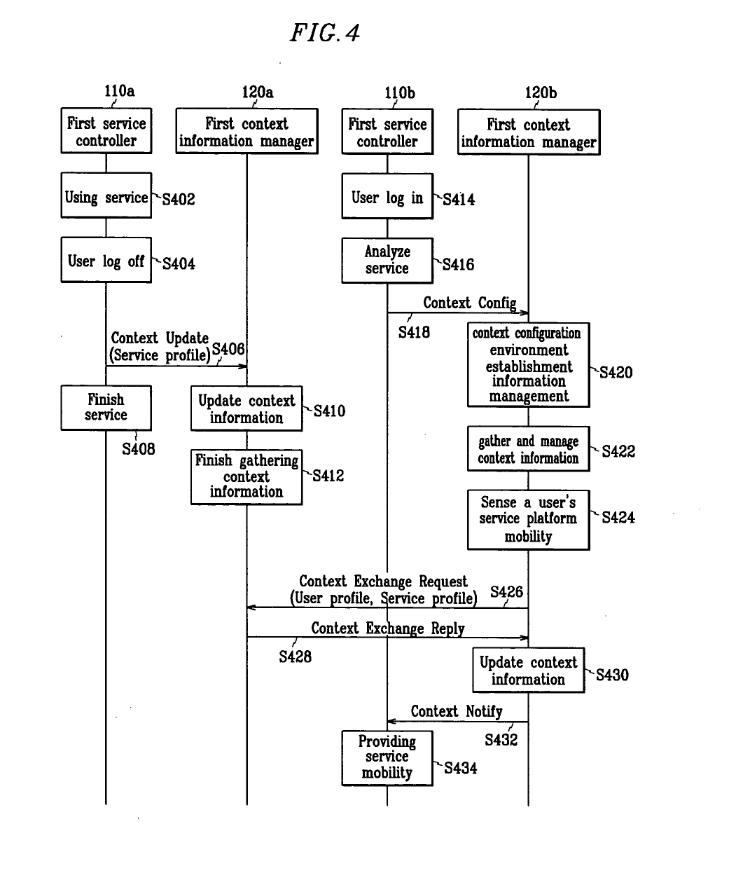

Subsequently, an operation of the context information management system according to an exemplary embodiment of the present invention will be described in detail with reference to FIG. 3 and FIG. 4.

FIG. 3 illustrates an operation process of a context information management system when a user makes an initial entry into a service environment. In FIG. 3, it is assumed that the user makes an initial entry into the first service environment.

As shown in FIG. 3, when the user makes an initial entry into the first service environment, the service controller 110a recognizes a user's log-in (S302) and analyzes a service using the user service subscription information of the first service environment (S304). The first service controller 110a requests the first context information manager 120a to configure a context by means of a context configuration request message Context Configure about the necessary context information and context information condition for the user's service requirement based on a service analyzing result (S306).

The first context information manager 120a receives the context configuration request from the first service controller 110a and configures the necessary context information environment, manages the context information (S308), gathers the context information required for the context configuration, and updates the context information (S310 to S312). When the context information conditions are formed, the context information is transmitted through the context notification message Context Notify to the first service controller 110a (S314).

The first service controller 110a starts to provide a service according to the context information received from the first context information manager 120a (S316).

Meanwhile, when the first service controller 110a receives additional service requirements from the user (S318), it requests the first context information manager 120a to provide additional context information through the context information request message Context Request (S320), and the first context information manager 120a transmits the additional context information through the context information response message Context Reply in response to the context information request message (S322).

FIG. 4 illustrates an operation process of a context information management system when a user moves into other service environments on the way of using a service. In FIG. 4, the user moves from the first service environment to the second service environment.

As shown in FIG. 4, when the user moves to the second service environment by way of being provided with a service by the first service controller 110a (S402), the first service controller 110a recognizes a user's log-off from the first service environment (S404). The first service controller 110a transmits such service profile information as the using service information to the first context information manager 120a through a context information update request message Context Update (S406) and finishes the using service (S408).

The first context information manager 120a receives the context information update request message from the first service controller 110a, updates the service profile information (S410), and finishes the gathering of the user context information (S412).

Meanwhile, the second service controller 410b recognizes a user's log in from the second service environment (S414), and analyzes a service using the user service subscription information from the second service environment (S416). In addition, the second service controller 410b requests the second context information manager 120b to configure the necessary context information and context information condition environment according to the service requirements based on the service analyzing result through the context configuration request message Context Config (S418).

The second context information manager 120b receives the context configuration request from the second service controller 110b, configures the necessary context information environment and manages the context information (S420), and gathers the context information required by the context configuration (S422). At this time, the second context information manager 120b senses user mobility from the first platform provided by the first service environment to the second platform provided by the second service environment using the user present and previous location information from the user location information among the gathered context information (S424). The second context information manager 120b senses the user mobility, and requests the first context information manager 120a of the first service environment to provide a context information exchange about the user profile information and the user service profile information for supporting the service mobility through the context information exchange request message Context Exchange Request (S426).

The first context information manager 120a receives the context information exchange request message from the second context information manager 120b, and transmits the requested user profile information and service profile information to the second context information manager 120b in response to the context information exchange request through the context information exchange response message Context Exchange Reply (S428).

The second context information manager 120b updates the user profile information and service profile information of the previous service environment received from the first context information manager 120a (S430). In addition, when the user context information conditions are formed, it transmits the context information to the second service controller 110b through the context information notification message Context Notify (S432), and the second service controller 110b provides the same service to the user using the user context information, along with the using service information and the user preference from the user profile information and service profile information, which are included in the context information notification message (S434). That is, the user may continuously utilize the using service as the same user preference in the first service environment although the user moves to another second service environment without the service terminal.

The above-described methods and apparatuses are not only realized by the exemplary embodiment of the present invention, but, on the contrary, are intended to be realized by a program for realizing functions corresponding to the environment establishment of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to an exemplary embodiment of the present invention, service mobility is provided that the user may continuously utilize the using service while applying the same user using preference although the user moves to other service environments without the service terminal on the way of using a service.

What is claimed is:

1. A context information management system for providing a user having moved service environments with service mobility, the context information management system comprising:
a service controller for providing a service according to context information and context information conditions for performing a service by analyzing a service based on the user subscription information when a user enters into a service environment; and
a context information manager for gathering and managing the context information for performing a service, and transmitting the context information of service used by the user in the pre-movement service environment to the service controller when a user's service environment mobility is sensed from the gathered context information,
wherein the service controller provides the same service to a user having moved to the service environment with the same user preferences by using the context information of the service used in the pre-movement service environment.

2. The context information management system of claim 1, wherein the service controller requests the context information manager to configure an environment on context information and context information condition for performing the service, and receives the context information satisfying context information conditions in response to the context configuration request.

3. The context information management system of claim 2, wherein the context information includes user location information, user profile information, device profile information, and service profile information.

4. The context information management system of claim 3, wherein the user location information includes user present and previous location information;
the user profile information includes user service preference information—the user service preference information including service device preference, automatic/manual preference of service mobility modes, and automatic/manual preference of service device selection modes,
the device profile information includes a list and specification information of device that the user may use in the present location; and
the service profile information includes the using service information.

5. The context information management system of claim 4, wherein the context information manager senses the user service environment movement based on the user location information among the configured and gathered context information.

6. The context information management system of claim 1, further comprising an information storage unit for storing the context information.

7. The context information management system of claim 5, further comprising an information storage unit for storing the context information.

8. A context information management method for providing service mobility to a user that moves from a first service environment to a second service environment, the context information management method comprising:
a) recognizing an entry of the user into the second service environment;
b) configuring a context information environment satisfying user service requirements by analyzing a service based on the user' service subscription information;
c) sensing a user's mobility from a first service environment to a second service environment by using the context information gathered by the context configuration; and
d) receiving the using service context information from the first service environment and providing the using service to the user of the second service environment with the same user preferences as that in the first service environment.

9. The context information management method of claim 8, further comprising, before step a), in the first service environment,
recognizing a user's exit; and
updating the context information including the using service information of user, and finishing the service.

10. The context information management method of claim 9, wherein the context information includes:
user location information including user present and previous location information;
user profile information including user service preference information;
device profile information including a list and specification information of device that is available in the user present location; and
service profile information including the service information used by the user in the service environment.

11. The context information management method of claim 10, wherein at step c), the user mobility to the second service environment is sensed using the user location information among the configured and gathered context information.
